(19) United States
(12) Patent Application Publication
(10) Pub. No.: US 2005/0216060 A1
(43) Pub. Date: Sep. 29, 2005

(54) Pacifier

(76) Inventor: Read McCarty, Pembroke, MA (US)

Correspondence Address: JAMES E. BRUNTON, ESQ., P. O. BOX 29000, GLENDALE, CA, 91209, US

(21) Appl. No.: 10/810,086

(22) Filed: Mar. 25, 2004

(51) Int. Cl. A61J 17/00

(52) U.S. Cl. 606/236; 606/234

(57) ABSTRACT

An infant pacifier having a uniquely configured guard assembly for engaging the infant's face to effectively prevent the pacifier from being accidentally swallowed or inhaled by the infant, while at the same time permitting free passage of nasogastric tubing. The guard assembly includes a generally U-shaped body having a front surface, a back surface, a generally rounded bottom portion and a concave upper portion, which permits passage of the nasogastric tubing. The infant pacifier also includes a nipple extending outwardly from the front surface of the guard, the nipple having an axial centerline concentric with said rounded bottom portion of the guard.

### BACKGROUND OF THE INVENTION

1. Field of the Invention

The present invention relates generally to infant pacifiers. More particularly, the invention concerns an infant pacifier that is uniquely configured to have a rounded bottom portion and an open top portion that permits the passage of nasogastric and other nasal tubing and prevents irritation of the infant's nose.

2. Discussion of the Prior Art

Conventional prior art infant pacifiers include an outwardly extending nipple portion and a substantially round guard which engages the infant's face to prevent the pacifier from being accidentally swallowed or inhaled by the infant. The provision of the guard component of the infant pacifier is required by the Consumer Product Safety Commission and Section 1511 of the published Consumer Product Safety Commission regulations requires that all pacifier designs be tested on a test fixture designed to verify that the pacifier meets this safety requirement. However, the generally circular shaped guard of the conventional prior art infant pacifiers can interfere with the use of nasogastric tubing and tends to irritate the infant by rubbing a hard surface against the nose. It is this drawback of the prior art pacifiers that the design of the pacifier of the present invention seeks to overcome.

### SUMMARY OF THE INVENTION

By way of summary the novel infant pacifier of the present invention comprises a uniquely configured guard assembly for engaging the infant's face to effectively prevent the pacifier from being accidentally swallowed or inhaled by the infant, while at the same time permitting free passage of nasogastric tubing. The guard assembly includes a generally U-shaped semi-rigid body having a front surface, a back surface, a generally rounded bottom portion and generally concave upper portion, which permits passage of the nasogastric tubing. Affixed to the upper portion of the U-shaped body portion is a strategically configured soft silicone overlay. The infant pacifier also includes a nipple extending outwardly from the front surface of the guard, the nipple having an axial centerline concentric with said rounded bottom portion of the guard. The nipple includes a bulbous forward portion and a rearward open portion which allows the infant caregiver to monitor the sucking habits of the infant and to orally stimulate the infant as maybe required.

With the foregoing in mind it is an object of the present invention to provide an infant pacifier which is uniquely configured to effectively prevent the pacifier from being accidentally swallowed or inhaled by the infant, while at the same time permitting passage of nasogastric and other nasal tubing.

It is another object of the invention to provide an infant pacifier of the aforementioned character which is uniquely configured to prevent the pacifier from rubbing against and irritating the nose of the infant during use.

It is another object of the invention to provide an infant pacifier as described in the preceding paragraphs in which the guard portion of the pacifier includes a generally U-shaped body portion constructed of a semi-rigid material and an upper, over-lay portion constructed of a soft, yieldable material.

Another object of the invention is to provide an infant pacifier that includes a uniquely configured nipple portion that is open on the opposite side from the infant's mouth to enable the infant caregiver to monitor the sucking habits of the infant and to orally stimulate the infant if necessary.

Another object of the invention is to provide an infant pacifier of the character described in the preceding paragraphs that is constructed from a non-allergenic, non-toxic, elastomeric material which is long-wearing, scuff resistant, heat resistant and inexpensive.

Another object of the invention is to provide an infant pacifier of the character described that can be easily cleaned and sanitized by conventional methods.

Another object of the present invention to provide a new and improved infant pacifier which can be efficiently and inexpensively manufactured.

Another object of the invention is to provide an infant pacifier of the character described here and which is of a durable and reliable construction.

### BRIEF DESCRIPTION OF THE DRAWINGS

FIG. 1 is a generally perspective rearview of one form of the infant pacifier of the present invention.

FIG. 2 of is a rear view of the infant pacifier shown in FIG. 1.

FIG. 3 is a front of view of the infant pacifier from shown in FIG. 1.

FIG. 4 is a cross-sectional view taken along lines 4-4 of FIG. 2.

FIG. 5 is a side elevational view of the infant pacifier.

FIG. 6 is a top plan view of the infant pacifier.

FIG. 7 is a bottom plan view of the infant pacifier.

### DESCRIPTION OF THE INVENTION

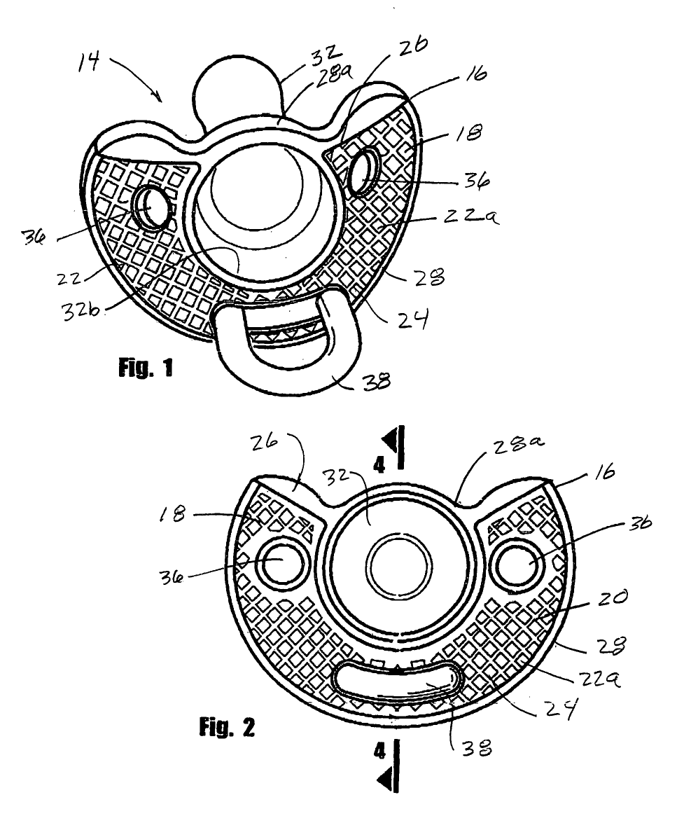

Referring to the drawings and particularly to FIGS. 1 through 4, one form of the infant pacifier of the present invention is there shown and is generally designated by the numeral 14. In this form of the invention of the infant pacifier comprises a guard assembly 16 for engaging the infant's face to prevent the pacifier from being accidentally swallowed or inhaled by the infant. The guard assembly herein includes a generally U-shaped body 18 which is constructed from a semi-rigid material such as plastic or high durometer silicon. As is seen in FIGS. 1, 2 and 3, body 18 has a front surface 20, a back surface 22, a generally rounded bottom portion 24 and an open, generally concave top portion 26. A soft silicone, textured over-lay 22a is affixed to the back surface 22 to form a laminate construction made up of a semi-rigid plastic material and a soft silicon over molded over the semi-rigid plastic.

The guard assembly also includes an upper, strategically shaped portion 28 that is preferably constructed from a soft, yieldable silicon material which is overlayed over concave top portion 26. When the pacifier is in the infant's mouth, the upper portion 26 resides beneath the infant's nose and permits the free passage of nasogastric and other nasel tubing; to the infant's nose. Additionally, because the soft rim portion 28a of the pacifier resides beneath the infant's nose, irritation of the character typically experienced through the use of conventional prior art pacifiers is effectively prevented.

Because of the novel shape of the pacifier guard, the choice of the materials and the careful dimensioning of the guard body, the guard assembly effectively prevents the pacifier from being accidentally swallowed or inhaled by the infant.

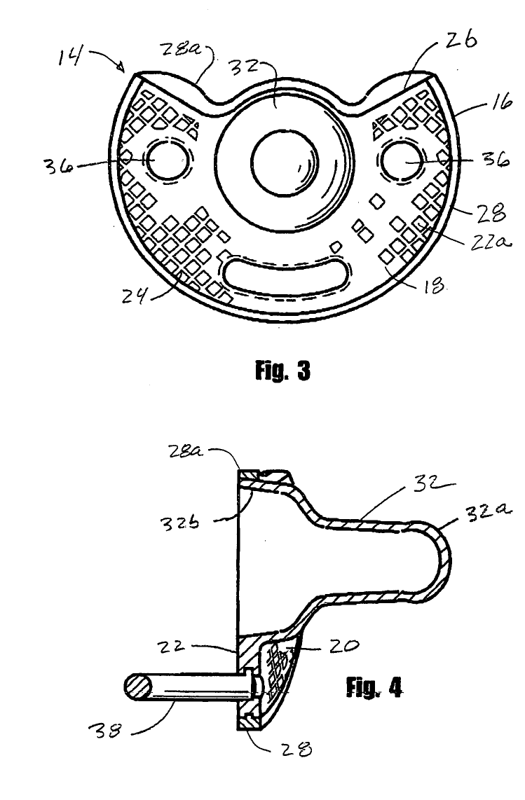

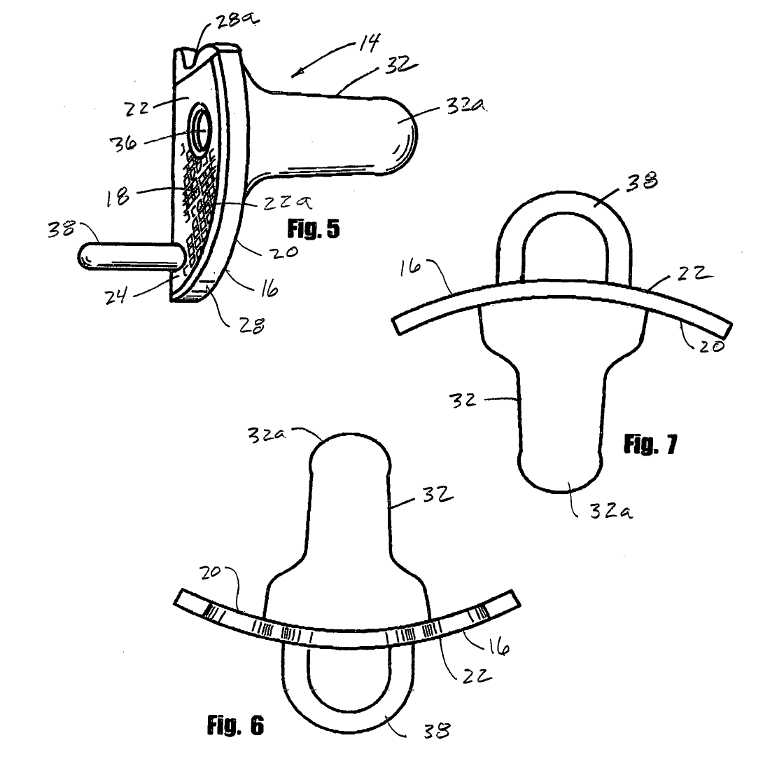

As shown in FIGS. 4 and 5, the infant pacifier of the present invention also includes a uniquely configured nipple 32 which extends outwardly from said front surface of said guard. As indicated in FIGS. 3 and 4, the nipple has an axial centerline 34 that is concentric with rounded bottom portion 24 of guard body 18. Nipple 32 includes a bulbous front portion 32a and a rearward open portion 32b that enables the infant caregiver to monitor the sucking habits of the infant and to orally stimulate the infant if necessary.

A pair of spaced apart apertures 36 are formed in the U-shaped body 18 and a generally U-shaped gripping handle 38 extends outwardly from back surface 22 of the guard to enable the caregiver to easily remove the pacifier from the infant mouth.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. An infant pacifier comprising:
(a) a guard assembly for engaging the infant's face to prevent the pacifier from being accidentally swallowed or inhaled by the infant, said guard assembly comprising a generally U-shaped body constructed from a semi-rigid material and having a front surface, a back surface, a bottom portion and a generally concave upper portion, said upper portion being constructed of a soft flexible material; and
(b) a nipple extending outwardly from said front surface of said guard, said nipple having an axial centerline concentric with said rounded bottom portion of said guard.

2. The infant pacifier as defined in claim 1 further including a gripping handle extending outwardly from said back surface of said guard.

3. The infant pacifier as defined in claim 1 in which said nipple includes a bulbous forward portion and a rearward open portion.

4. The infant pacifier as defined in claim 1 in which said body comprises a laminate construction comprising a first semi-rigid material and a second soft material affixed to said first semi-rigid material.

5. The infant pacifier as defined in claim 4 in which said first material comprises a substantially rigid plastic material and said second material comprises a soft, flexible silicone material.

6. An infant pacifier comprising:
(a) a guard assembly for engaging the infant's face to prevent the pacifier from being accidentally swallowed or inhaled by the infant, said guard assembly comprising:
(i) a generally U-shaped body constructed from a semi-rigid material and having a front surface, a back surface, an upper concave portion and a bottom portion; and
(ii) an overlay overlaying said upper concave portion, said overlay being constructed of a soft flexible material;
(b) a nipple extending outwardly from said front surface of said guard, said nipple having an axial centerline concentric with said rounded bottom portion of said guard; and
(c) a generally U-shaped handle extending outwardly from said back surface of said guard.

7. The infant pacifier as defined in claim 6 in which said nipple includes a bulbous forward portion and a rearward open portion.

8. The infant pacifier as defined in claim 6 in which said semi-rigid material comprises a plastic material and in which said soft, flexible material comprises a silicone.

9. The infant pacifier as defined in claim 6 in which said generally U-shaped body is provided with a pair of oppositely disposed openings.

10. An infant pacifier comprising:
(a) a guard assembly for engaging the infant's face to prevent the pacifier from being accidentally swallowed or inhaled by the infant, said guard assembly comprising:
(i) a generally U-shaped body constructed from a semi-rigid material and having a front surface, a back surface, a generally rounded bottom portion and a concave upper portion; and
(ii) a soft flexible member affixed to said concave upper portion of said body;
(b) a nipple extending outwardly from said front surface of said guard, said nipple having an axial centerline concentric with said rounded bottom portion of said guard and further includes a bulbous front portion and a rearward open portion; and
(c) a generally U-shaped handle extending outwardly from said back surface of said guard.

11. The infant pacifier as defined in claim 10 in which said guard assembly further comprises a soft flexible material over molded over said generally U-shaped body.

12. The infant pacifier as defined in claim 10 in which said generally U-shaped body is provided with a pair of oppositely disposed openings.
